(19) United States
(12) Patent Application Publication
(10) Pub. No.: US 2011/0015969 A1
(43) Pub. Date: Jan. 20, 2011

(54) SYSTEM AND METHOD FOR COLLECTING CONSUMER INFORMATION PREFERENCES AND USAGE BEHAVIORS IN WELL-DEFINED LIFE CONTEXTS

(75) Inventor: Shoshana Loeb, Philadelphia, PA (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/627,360

(22) Filed: Nov. 30, 2009

Related U.S. Application Data
(60) Provisional application No. 61/226,908, filed on Jul. 20, 2009.

(51) Int. Cl. G06Q 10/00; G06Q 30/00; G06F 3/048

(52) U.S. Cl. 705/10; 715/764

(57) ABSTRACT

A system and method for collecting consumer information includes a data storage device included in a computer system. A data interface for use by a user offers services from a service provider. The services are selectable by the user. Event data of the user's activity is collected using the data interface. Timeline data is collected during the user's activity from the service provider. Also, personal user data is collected and the personal user data is anonymized. The event data, the timeline data, and the anonymized personal user data are correlated. A model of the user's preferences is prepared and displayed.

### CROSS-REFERENCE TO RELATED APPLICATION

This application claims priority under 35 U.S.C. §119(e) of U.S. Provisional Patent Application Ser. No. 61/226,908, filed Jul. 20, 2009, the disclosure of which is hereby incorporated by reference in its entirety.

### FIELD OF THE INVENTION

The present invention relates generally to a system and method for collecting and analyzing data about a user's preferences, and more particularly, the present invention relates to a system and method for collecting and analyzing data about a user's preferences and providing a statistical model of the user's preferences.

### BACKGROUND OF THE INVENTION

Collecting accurate data of context-sensitive information/data about consumer information/entertainment preferences is problematic. For example, obtaining data regarding interests and usage behavior is a difficult task. One method of collecting data is for marketers to design focus groups in which they test user preferences in a lab setting, and administer questionnaires, for example, what-if questionnaires. Another method of collecting data is for a company to install specialized equipment in a selective group of people's homes and monitor their TV viewing habits for the purposes of rating various shows' popularity.

Other technologies and methodologies include segmentation based on demographics and user modeling techniques such as collaborative filtering for monitoring and predicting people's information preferences for recommending books and movies. However, difficulties and shortcomings occur with current methods which monitor a person's information/data consumption in a natural (e.g., home) environment, as opposed to a lab setting. One problem with current methods is that it is difficult to determine the context in which people are consuming the information/data (or entertainment), for example, events occurring in the background while the information is being consumed by the user, or other persons being in the room. The accuracy of collected information is low due to the inability to capture the context (e.g., context events) of the collected information. Even when a collection method is applied to a statistically chosen group, such as collecting data (for example TV viewing) for a group of homes, the accuracy of the collected information can be less than desirable due to the inability to capture the context of the viewing data. Therefore, it is difficult to collect high quality preference information for accurate predictions, because in known approaches, the profiling system does not know the user context and time-line of events.

It would therefore be desirable to provide a system and method for collecting accurate information/data from a consumer in a non-lab setting. There is a further need for the system and method of collecting data to provide accurate environmental data about the circumstances and environment of the consumer while the data is being collected.

### SUMMARY OF THE INVENTION

In an aspect of the invention, a method for collecting consumer information comprises: providing a data storage device included in a computer system, the computer system including a program stored in the data storage device and steps of the program being executed by a processer; providing a data interface for use by a user, the data interface offering services selectable by the user from a service provider; collecting event data of the user's activity using the data interface; collecting timeline data during the user's activity from the service provider; collecting personal user data; anonymizing the personal user data; correlating the event data, the timeline data, and the anonymized personal user data; and preparing and displaying at least one model of the user's preferences.

In a related aspect, after the step of preparing and displaying, the method further comprises creating at least one profile for each of a plurality of users, wherein each profile includes categories of information about the corresponding user. Alternatively, the method, after the step of preparing and displaying, may further comprise creating a plurality of profiles for each of a plurality of users, wherein each profile includes categories of information about the corresponding user. In a related aspect, the event data and the timeline data occur during the same period of time. The user data may be provided by the service provider and/or provided by the user.

In another aspect of the present invention, a computer program product comprising a computer readable medium has recorded thereon a computer program. A computer system includes a processor for executing the steps of the computer program for generating a model of consumer preferences. The computer program product uses a data interface for collecting data about services provided to the user by a service provider, the program steps comprising: collecting event data of the user's activity using the data interface; collecting timeline data during the user's activity from the service provider; collecting personal user data; anonymizing the user data; correlating the event data, the timeline data, and the anonymized user data; and preparing and displaying at least one model of the user's preferences.

In a related aspect, the computer program product, after the step of preparing and displaying, further comprises creating at least one profile for each of a plurality of users, wherein each profile includes categories of information about the corresponding user. Alternatively, the computer program product, after the step of preparing and displaying, further comprises creating a multiplicity of profiles for each of a plurality of users, wherein each profile includes categories of information about the corresponding user.

In another aspect of the invention, a system for collecting consumer information comprises a computer system including a program stored in a data storage device and steps of the program are executed by a processer. This aspect may include a data interface for use by a user, wherein the data interface offers services from a service provider selectable by the user. An event logging module collects event data of the user's activity using the data interface. A data compiling module generates timeline data of the user's event data, and generates timeline data of events context. A server communicates with the computer system and stores the event data of the user's activity using the data interface. The server stores the timeline data of the user's events and the timeline data of the events context, and stores personal user data. A correlating module for anonymizing the personal user data can exist. The correlating module correlates the event data, the timeline data, and the anonymized personal user data, the correlating module generating at least model of the user's preferences. A display presents the at least a one model of the user's preferences.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a system and method for collecting and analyzing consumer information according to an embodiment of the invention;

FIG. 2 is a block diagram depicting correlating timelines of user events; and

FIG. 3 is a flow chart illustrating a method according to an embodiment of the invention for collecting and analyzing consumer information.

### DETAILED DESCRIPTION OF THE INVENTION

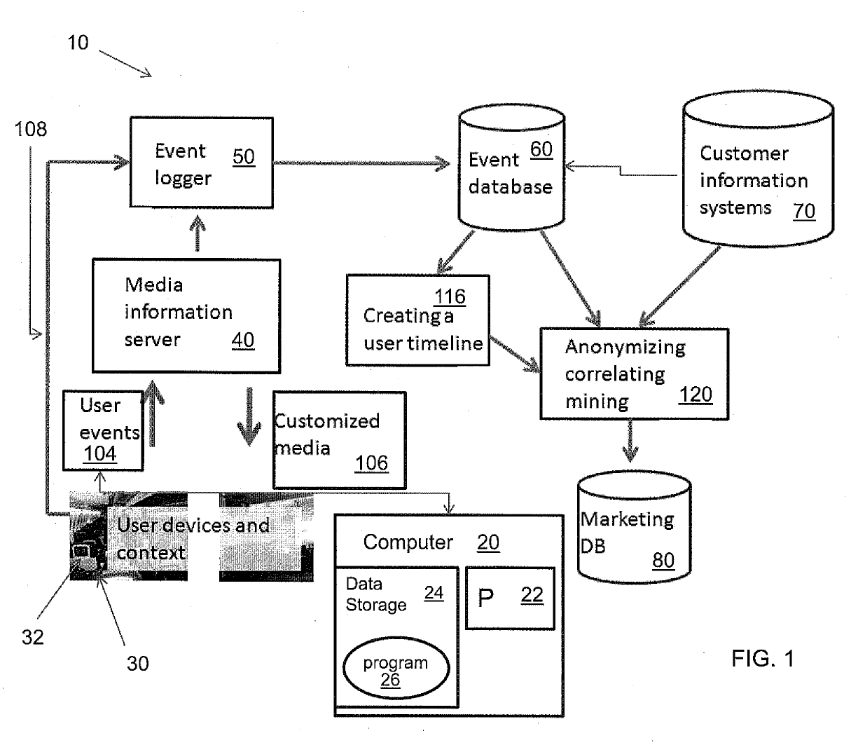

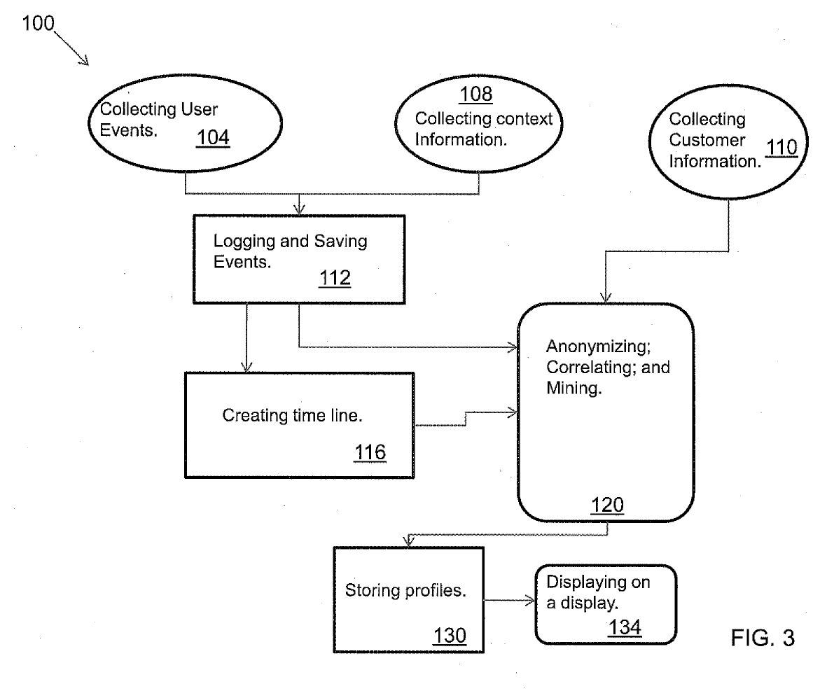

Referring to FIG. 1, a system and method 10 for collecting and analyzing consumer information and usage behaviors includes a computer system 20 communicating with or including a server 40. The system and method 10 collects data reflecting user preferences, for example, in situations in which consumers are situated in a designated service provider space. For example, in the embodiment shown in FIG. 1, a seat 30 in an airline passenger cabin provides a designated service provider space. In the embodiment of the invention shown in FIG. 1, the user's identity is known by the airline and stored in a customer information system 70. The user is offered entertainment and information, e.g., to pass the time while waiting, such as offering large selections of movies and games for customer on long distance flights. The system 10 collects the user's selections. The user's selections are events which may include, for example, selecting a program from a viewing menu, browsing and/or selecting information or entertainment, and starting and stopping searches, viewing, downloading, or modifying, the selections. Data reflecting a user's selections or use is sent to the server 40, and the data is anonymized, i.e., the user's personal information as well as context information from the service provider relating to the user's personal information, is removed or modified to anonymize the information, thereby protecting the user's privacy and identity. Anonymizing the user's information occurs in step 120, and a profile for each user in various categories is created. To further protect the user's privacy, user information may be anonymized and aggregated before a user leaves the provider space. However, even with additional anonymization, the aggregate data provides valuable information about user interests and behavior based on the various context and demographic parameters that would not be otherwise collected. The profiles are stored in a marketing database 80 and used for marketing and advertizing purposes by the service provider and other interested entities in step 130 of FIG. 3. The server 40 includes or accesses a software program 26 which creates models of the users' behaviors in context of usage. The models can be used to profile categories of users. The model can be displayed on a display as referred to step 130 of FIG. 3.

More specifically, referring to FIG. 1, the system 10 is applied to airline passengers as users, and the system 10 accesses in-flight information and entertainment systems. In the embodiment of the invention shown in FIG. 1, each seat 30 on the flight is equipped with a touch screen TV monitor 32 that allows the user to select movies, or programs or games from a large selection (for example, movies organized into categories). The centralized in-flight entertainment server 40 receives the user's commands and delivers the information to the user in step 106. The information could be customized using the system and method of the present invention. The user requests are logged in event logger 50 for future use. The log includes usage selections by the user of the in-flight entertainment system, for example, flight information, seat information, time, and users' requests. Also, the context of the usage or context events are sent to and recorded by the server 40, in step 104. For example, when meals are served, or when other events occur, the context event is recorded by the server 40, and subsequently logged in the event logger 50. During, or after the flight, the information is transmitted to an event database 60 for storage, in step 112.

The information in the event logger 50 is combined with known information from the airline about the person who was in the seat 30, for example, user information retrieved from the customer information system 70. For example, user information may include demographic information such as address, age, and family situation, e.g., marital status, as well as travel destination which may be indicative of occupation or of country of origin and ethnic background. The information in the event logger 50 is also combined with information retrieved from the touch screen TV monitor 32. The combination of information can be accomplished in several manners, for example, in the embodiment of the invention shown in FIG. 1, during the correlation/anonymization step 120; however, the combination of information may occur before or after anonymization. The information is analyzed and a time-line is created for a particular user's activities in step 116. A time line may depict, for example, when movies start and stop, when a meal is served, etc. The information from the event database 60 may be further analyzed to conclude, for example, which movies the user watched to completion, which movies were interrupted, what did the user browse on the touch screen 32, etc. This data is further correlated with additional data in the correlation mining step 120, from the server 40 directed to the service provider, for example, correlating flight length, flight origin and destination, etc. Further, user or customer information is stored in the customer information system database 70 for direct use in the correlation mining step 120. Information from the customer database 70 may include, for example, as indicated above, country of origin, flight history over the last several months, movies watched in previous flights, or whether the user is alone or traveling in a group. All of the data is used to create a real time, as well as an off line, profile for users. The profile can subsequently be used to market to individual users and targeted groups of users. For example, in the embodiment of the invention shown in FIG. 1, the profile can be used to provide information to the user for selection as in step 106.

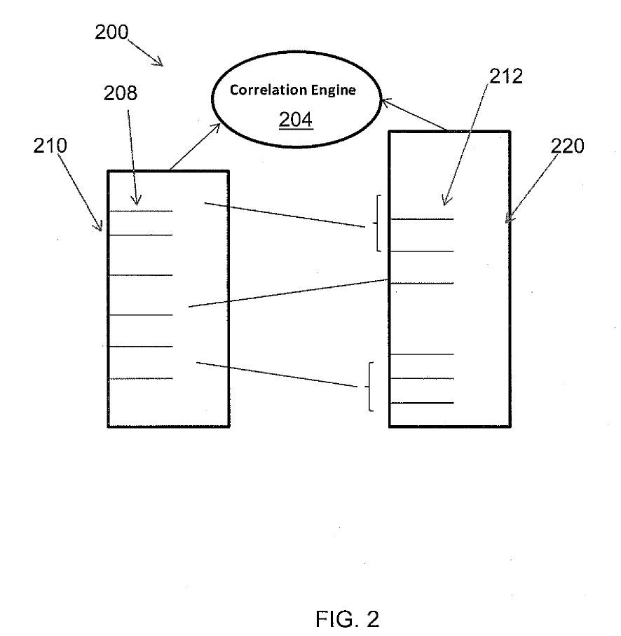

Referring to FIGS. 1 and 2, the user event timeline 220 is correlated with the context time line 210, as in step 120 in the embodiment of the invention shown in FIG. 1, thus the in-flight events, are correlated with the context time line. A more in-depth correlation can be performed between the same user's behavior in other flights where the context was different (different flight length, different time of day, flying with or without family, sitting next to another passenger or not, etc). A correlation engine 204 is used to correlate service provider event information 208, and user initiated event information 212, in respective timelines 210, 220.

Thus, the present invention provides a system and method for determining the context in which people are consuming the information/entertainment in a natural (non lab) setting, and collecting quality preference information for quality statistical analysis and predictions. In another embodiment of the invention, the system and method 10 may be applied when people are in a waiting room (e.g., in a doctor's office) and have access to electronic information, or when a guest is staying in a hotel. Correlation of the user event data, with records from the service providers regarding the user's information (after anonymization) and demographics, and further aggregating context information provided by the service provider, results in relatively large amounts of information collected and used for user modeling and targeting. The system and method described above can be applied in many situations, for example, anywhere users are confined to a space for a period of time and are exposed to information that they control, and at the same time, have events imposed upon them by the service provider. Thereby, the present invention leverages closed environments such waiting areas, e.g., garage, hospital room, hotel room, etc.

Further, the invention disclosed herein includes monitoring two parallel time-lines, that is, the user time-line as determined by the service provider, and the information viewing time-line determined by the user's selections. The correlation of these two time-lines in the controlled space results in enhanced user behavior information usable for creating profiles of users, and ultimately for marketing to an individual user or group of users.

Referring to FIGS. 3 and 1, the method 100 of the embodiment of the invention shown in FIG. 1 includes collecting user events in step 104 and collecting context information in step 108 for logging and storing events in step 112. The user events are initiated by the user selecting preferences on the monitor 32 (FIG. 1), and the context of the usage and/or events is sent to the server 40 in step 108. The information is transmitted to the event logger 50 and the database 60 (FIG. 1) for storage, in step 112. The user timelines are created in step 116 from the event logging stored in the event database 60. The timelines, the information in the event database 60, and customer information collected in step 110 are combined in step 120 for anonymizing, and correlating all the information/data. Thus, correlating mining step 120 includes correlating all the data, and anonymizing data having personal information about the user. Step 120 further includes creating a real time and off-line profile of each user using correlated data from all the sources correlated in step 120. Further, step 120 provides data mining used to provide user models for predicting user information needs and preferences, for example, for use in marketing products and services.

As will be appreciated by one skilled in the art, the present invention may be embodied as a system, method or computer program product. Furthermore, the present invention may take the faun of a computer program product embodied in any tangible medium of expression having computer usable program code embodied in the medium. In the present invention, any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate medium, including but not limited to wireless, wireline, optical fiber cable, RF, etc. Computer program code for carrying out operations of the present invention may be written in any combination of one or more programming languages, including for example, object oriented programming languages. Computers, for example, user's computer and servers, may communicate and be connected using any type of network, including a local area network (LAN) or a wide area network (WAN), or the connection may be made to an external computer (for example, through the Internet using an Internet Service Provider).

The present invention is described with reference to flowchart illustrations and/or block diagrams, or schematic diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer program instructions. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for collecting consumer information, comprising:
providing a data storage device included in a computer system, the computer system including a program stored in the data storage device and steps of the program being executed by a processer;
providing a data interface for use by a user, the data interface offering services selectable by the user from a service provider;
collecting event data of the user's activity using the data interface;
collecting timeline data during the user's activity from the service provider;
collecting personal user data;
anonymizing the personal user data;
correlating the event data, the timeline data, and the anonymized personal user data; and
preparing and displaying at least one model of the user's preferences.

2. The method of claim 1, after the step of preparing and displaying, further comprising:
creating at least one profile for each of a plurality of users, wherein each profile includes categories of information about the corresponding user.

3. The method of claim 1, after the step of preparing and displaying, further comprising:
creating a plurality of profiles for each of a plurality of users, wherein each profile includes categories of information about the corresponding user.

4. The method of claim 1, wherein the event data and the timeline data occur during the same period of time.

5. The method of claim 1, wherein the user data is provided by the service provider and/or provided by the user.

6. A computer program product comprising a computer readable medium having recorded thereon a computer program; a computer system including a processor for executing the steps of the computer program for generating a model of consumer preferences, the computer program product using a data interface for collecting data about services provided to the user by a service provider, the program steps comprising:
collecting event data of the user's activity using the data interface;
collecting timeline data during the user's activity from the service provider;
collecting personal user data;
anonymizing the user data;
correlating the event data, the timeline data, and the anonymized user data; and
preparing and displaying at least one model of the user's preferences.

7. The computer program product of claim 6, after the step of preparing and displaying, further comprising:
creating at least one profile for each of a plurality of users, wherein each profile includes categories of information about the corresponding user.

8. The computer program product of claim 6, after the step of preparing and displaying, further comprising:
creating a multiplicity of profiles for each of a plurality of users, wherein each profile includes categories of information about the corresponding user.

9. The computer program product of claim 6, wherein the event data and the timeline data occur during the same period of time.

10. A system for collecting consumer information, comprising:
a computer system including a program stored in a data storage device and steps of the program being executed by a processer;
a data interface for use by a user, the data interface for offering services from a service provider selectable by the user;
an event logging module for collecting event data of the user's activity using the data interface;
a data compiling module for generating timeline data of the user's event data, and generating timeline data of events context;
a server communicating with the computer system and storing the event data of the user's activity using the data interface, the server storing the timeline data of the user's events and the timeline data of the events context, and storing personal user data;
a correlating module for anonymizing the personal user data, the correlating module correlating the event data, the timeline data, and the anonymized personal user data, the correlating module generating at least model of the user's preferences; and
a display for presenting the at least one model of the user's preferences.

11. The system of claim 10, wherein the correlating module generates a profile for each of a plurality of users, wherein each profile includes categories of information about the corresponding user.

12. The system of claim 10, wherein the event data and the timeline data occur during the same period of time.

13. The system of claim 10, wherein the user data is provided by the service provider and/or provided by the user.
